(19) United States
(12) Patent Application Publication
(10) Pub. No.: US 2025/0207729 A1
(43) Pub. Date: Jun. 26, 2025

(54) SYSTEM FOR FAST-FILL REFUELLING OF A CRYOGENIC CONTAINER OF A VEHICLE

(71) Applicants: Cryoshelter LH2 GmbH, Dobl-Zwaring (AT); Cryoshelter BioLNG GmbH, Dobl-Zwaring (AT)

(72) Inventors: Matthias REBERNIK, Dobl-Zwaring (AT); Ludwig MICHAL, Dobl-Zwaring (AT)

(21) Appl. No.: 18/850,145

(22) PCT Filed: Mar. 20, 2023
(86) PCT No.: PCT/AT2023/060079

§ 371 Date: Sep. 24, 2024

(30) Foreign Application Priority Data
Mar. 24, 2022 (AT) GM 50059/2022

(51) Int. Cl. F17C 6/00

(52) U.S. Cl. CPC F17C 6/00; F17C 2203/0391; F17C 2203/0629; F17C 2205/0352; F17C 2221/012; F17C 2221/033; F17C 2223/0161; F17C 2265/065; F17C 2270/0168

(57) ABSTRACT

The disclosure relates to a system for fast-fill refuelling of a cryogenic container that includes a vehicle. The cryogenic container is mounted on the vehicle. The system also includes an ancillary system for filling the cryogenic container with cryogenic fluid and for removing cryogenic fluid from the cryogenic container. The ancillary system includes a filling line with a filling coupling and a removal line routed to a consumer, with the filling line and the removal line each being routed into the cryogenic container separately or via a common connection line, wherein the removal line or the connection line is thermally connected to the filling line and/or the filling coupling by means of a permanent or connectible thermal bridge or the removal line is routed back through a section of the filling line.

### BACKGROUND

The invention relates to a system for fast-fill refuelling of a cryogenic container comprising a vehicle, the cryogenic container mounted on the vehicle and an ancillary system for filling the cryogenic container with cryogenic fluid and for removing cryogenic fluid from the cryogenic container, the ancillary system comprising a filling line with a filling coupling and a removal line routed to a consumer, with the filling line and the removal line each being routed into the cryogenic container separately or via a common connection line.

According to the prior art, liquefied gases can be stored in containers (“cryogenic containers”) so as to be stored as a fuel for a consumer such as an engine, for example. Liquefied gases are gases that are in the liquid state at boiling temperature, with the boiling temperature of this fluid being pressure-dependent. If such a cryogenic liquid is filled into a cryogenic container, a pressure corresponding to the boiling temperature is established, apart from thermal interactions with the cryogenic container itself.

In the application field of automotive engineering, the cryogenic fluid can serve as a fuel for a vehicle, for which purpose the cryogenic container is carried along on the vehicle. Cryogenic containers are usually mounted on the side of the vehicle frame, and the cryogenic containers must have enough insulation capacity so that the cryogenic fluid will remain in the cryogenic container at a low temperature for as long as possible, since those containers are not actively cooled, at least when the vehicle is at a standstill.

For example, hydrogen at a temperature of up to −253° C. is filled into the cryogenic container, with the cryogenic fluid located in the cryogenic container steadily heating up due to the constant heat input into the cryogenic container, whereby the pressure in the cryogenic container rises as well. As soon as the pressure in the cryogenic container exceeds a certain threshold, gaseous cryogenic fluid is discharged from the container for the purpose of pressure reduction. Thus, on the one hand, the endeavour is made to improve the insulation capacity of the cryogenic container in order to reduce the heat input therein so that the time span after which cryogenic fluid is discharged from the cryogenic container is increased.

On the other hand, however, this insulation causes the contents of the cryogenic container to remain cold, while external fittings, in particular the filling coupling, have a warm temperature corresponding, for example, to the ambient temperature. While this is beneficial for the general insulation quality of the cryogenic container, the refuelling process is thereby slowed down. The reason for this is that the warm filling coupling must first be cooled down to the temperature of the cryogenic fluid when refuelling with the cryogenic fluid provided by the filling station in a cold state. In other words, the first cryogenic fluid fed from the filling station into the filling coupling will evaporate until the filling coupling and the filling line are cold enough to transfer the cryogenic fluid into the cryogenic container without evaporation.

### BRIEF SUMMARY

It is the object of the invention to improve the systems known from the prior art in such a way that faster refuelling of the cryogenic container becomes possible.

According to the invention, this object is achieved by a system for fast-fill refuelling of a cryogenic container comprising a vehicle, the cryogenic container mounted on the vehicle and an ancillary system for filling the cryogenic container with cryogenic fluid and for removing cryogenic fluid from the cryogenic container, the ancillary system comprising a filling line with a filling coupling and a removal line routed to a consumer, with the filling line and the removal line each being routed into the cryogenic container separately or via a common connection line, wherein the removal line and/or the connection line is/are thermally connected to the filling line, the filling coupling and/or a connecting line connected to the filling line by means of a permanent or connectible thermal bridge or that the removal line and/or the connection line is/are routed back through a section of the filling line and/or the connecting line. If a permanent thermal bridge is used, it is formed by a heat-conducting connection, preferably by a cable, a mesh, a plate or a film, or by a direct contact (of the removal line or the connection line on the one hand and the filling line or the connecting line on the other hand). A heat-conducting connection is understood to be a low-mass connection, i.e., one that has no mass, if possible. Direct contact means that the removal line or the connection line is routed to the filling line or the connecting line, contacting the latter. To ensure that there is a thermal connection, a film, for example, can be wrapped around the two lines which contact each other.

All claimed variants have in common in each case that a connection of the removal section and the filling section that is as massless as possible is achieved. Thus, de facto no additional mass is added to the system (with regard to both a thermal mass and a weight mass) and fast-fill refuelling as described below is achieved at the same time. If a permanent thermal bridge is provided, the mass being added is limited by the one-dimensional connection (a cable or mesh with point-like contacts on the lines) or the two-dimensional connection (a plate or film with line-like contacts on the lines). A low-mass heat-conducting connection could also be formed by a contact piece for two lines located essentially side by side (e.g., a work piece with two semi-cylindrical recesses on opposite sides for accommodating the lines). With a direct contact, no additional mass is required at all, except for a wrap or the like, if necessary. The temporary thermal bridge requires only a switch (which optionally can be integrated into one of the above-mentioned heat-conducting connections) so that only a small weight mass is added and the thermal mass can even be switched off completely. By routing back a line through another line, the weight mass can even be reduced, since parts of the line are used twice.

The solution according to the invention has the advantage that the filling line is also cooled during the operation of the system, i.e., when cryogenic fluid is being removed from the removal line. Surprisingly, however, this loss of cold during removal does not constitute a disadvantage, but an advantage, since the cryogenic fluid has to pass through an evaporator anyway to be heated before being supplied to the consumer in order to supply the consumer with the cryogenic fluid at a predetermined minimum temperature. In other words, the heat input into the removed cryogenic fluid is actually desirable, because the consumer must be supplied with heated gas that is usually warmer than −40° C. The operation of a heat exchanger (“vaporizer”) located in the removal line is thus facilitated by the heat input through the cooling of the filling coupling.

Therefore, by cooling the filling line or, respectively, the filling coupling, it can be accomplished that, immediately after a journey, the filling coupling has a temperature essentially corresponding to the temperature of the cryogenic fluid, minus minor heat losses at the thermal bridge, the filling line, the filling coupling, etc. Subsequently, cryogenic fluid can be filled into the filling coupling, which now is cold, or, respectively, into the cold filling line immediately after a journey, without the need to cool the filling coupling beforehand and without unnecessary loss of time and thermal energy.

Another advantage which should be mentioned is that such a thermal bridge also does not increase, or does not significantly increase, the usual heat input of heat into the cryogenic container when the vehicle is parked, especially if the measures mentioned below are implemented, such as the thermal bridge switch or a permanent thermal bridge with connections to points on the filling line or, respectively, the removal line with a temperature gradient that is the same.

In a particularly preferred embodiment, the cryogenic container has an inner tank and an outer container that is vacuum-insulated relative to the inner tank, and the thermal bridge or the section for return is provided in the space between the inner tank and the outer container, with the thermal bridge or the section for return preferably being provided at points on the filling line and the removal line where an identical temperature is established after the system has come to a standstill. These points are generally referred to as points with an identical temperature gradient. A standstill of the system is regarded to be a state in which neither cryogenic fluid is being filled into the cryogenic container via the filling line nor cryogenic fluid is being removed via the removal line. This embodiment is particularly preferred if the system does not comprise a thermal bridge switch, since, in this embodiment, no heat will flow across the thermal bridge after the system has been switched off. Furthermore, in this embodiment, it is preferred if the thermal bridge on the filling line is indeed arranged in the vacuum-insulated space, but preferably as closely to the outer container as possible, i.e., particularly preferably directly next to it, in order to also efficiently cool the filling coupling located outside of the outer container.

The following explanation is put forward as background to such considerations. The “lines” of a cryogenic container extend, among other things, from the feedthrough points in the outer container as far as to the feedthrough into the inner tank. During the hold time—i.e., there is no flow through any line (no removal, no refuelling, no boil-off)—the heat input is particularly critical, since the heat input should be minimized in order to maximize the hold time. In this phase, a temperature curve is established along each line. It begins approximately at the feedthrough point through the outer container with the ambient temperature prevailing in the respective case (minus a few degrees for the heat transfer from the air to the outer container) and ends at the feedthrough point on the inner tank with the storage temperature of the cryogenic fluid. The substantial heat flow across this pipeline occurs through thermal conduction along the pipe, exchange of thermal radiation with the environment and heat convection within the pipeline and can be reduced to an acceptable, low level if implemented professionally. The heat flow is determined by the wall thickness of the pipe, the length between the inner tank and the outer container and the thermal conductivity of the pipeline material, usually stainless steel. Since cross-section and wall thickness are largely determined by safety-related objectives, the length remains as the main design feature—the longer, the lower the heat flow.

In such a structure, the temperature curve can be taken into account: In a first approximation and assuming a temperature-independent thermal conductivity of the pipe material and a constant wall thickness, a linear temperature curve is established. If two lines are now interconnected with a thermal bridge at points having the same temperature, no heat will flow through this connection in the absence of a temperature difference and, therefore, the heat flow across the lines from the outer container into the inner tank will also not experience any relevant change. Local changes in wall thickness, such as, e.g., valve bodies, result in a temperature curve that is flatter in this area (i.e., a smaller temperature difference per unit length).

In case of varying operating conditions, i.e., refuelling, the pipeline concerned will be cooled down to the temperature of the cryogenic fluid across its entire length—i.e., from the outer container to the inner tank. This means that the inflowing cryogenic fluid withdraws from the pipeline (including the valve body and all connected components) precisely the amount of energy that is required for this cooling from the initial state (the stationary hold-time state, or, e.g., warm refuelling) to the cryogenic state. This amount of energy corresponds to the heat capacity of the pipeline in accordance with this change of state. What is added is the dissipation of the respective heat which is then still flowing in, for example, during refuelling, which, however, is typically of secondary importance.

From the above considerations, it is again evident that it is the primary objective of the invention to enable fast-fill refuelling by cooling the filling line during the operation of the system. The secondary objective of the invention is that no heat will flow through the thermal bridge according to the invention during a standstill of the system, i.e., during the hold time.

Especially if the thermal bridge is designed so as to be permanent, i.e., no thermal bridge switch is used, it is preferred if the heat capacity or the length of the filling line and the removal line between the cryogenic container and the thermal bridge or, respectively, the point at which the removal line is routed back into the filling line is essentially of the same magnitude. As a result, it is achieved that there will be no additional heat input into the cryogenic container after the system has been switched off, i.e., the two ends of the thermal bridge heat up at the same rate due to the temperature input from the outside. The period of time after which cryogenic fluid is discharged from the cryogenic container upon the removal or, respectively, after refuelling therefore remains unchanged in comparison to a system without a thermal bridge or, respectively, return.

Furthermore, the length of the filling line and/or the removal line between the cryogenic container and the thermal bridge or, respectively, the point at which the removal line is routed back into the filling line preferably ranges essentially between 300 mm and 700 mm.

In one variant, the aforementioned thermal bridge switch can be operated manually. However, it is preferred if the system comprises a control device which is designed for switching the thermal bridge on and off, with the control unit preferably being designed for switching the thermal bridge on when cryogenic fluid is being removed via the removal line and/or for switching the thermal bridge off when no cryogenic fluid is being removed via the removal line. The thermal bridge switch could be designed, in particular, as a normally open switch and could be connected to vehicle electronics so that the switch is opened as soon as the vehicle is stationary and closed as soon as the vehicle and/or its electronics is/are started.

Moreover, for a thermal bridge switch, it is preferred if it is located closer to the connection point to the filling line or, respectively, the filling coupling than to the connection point to the removal line.

As already mentioned, a heat-conducting connection is preferably provided for the permanent or temporary thermal bridge in order to configure the connection between the removal section and the filling section with no mass, if possible. A heat-conducting connection designed as a cable, mesh, plate or film involves the additional advantage that the filling section and the removal section can be at a spatial distance from each other so that existing systems can also be retrofitted without having to re-lay the lines. The heat-conducting connection is preferably made of metal. Furthermore, a heat-conducting layer enclosing the respective line is preferably provided, preferably an aluminium strip, which is connected to the heat-conducting connection. Therefore, the ancillary system does not need to be redesigned, since the thermal bridge can interconnect the spaced-apart lines.

In a further preferred embodiment, the filling line and the removal line or the connection line are located directly next to each other at this point to form the thermal bridge and contact each other there, and/or a heat-conducting layer wrapped around the two lines is provided and/or wherein the two lines are spaced apart at a predetermined distance, which amounts, for example, to a maximum of 10 cm or 20 cm, and can be selectively contacted using the thermal bridge switch. As a result, a direct transfer of heat may occur, resulting in faster cooling than with a contact involving a cable.

For vehicles, it may be advantageous to mount two cryogenic containers on the vehicle frame, e.g., one on the left and one on the right, viewed in the direction of travel, and/or at least one or at least two behind the driver's cab, horizontally and/or vertically. The two cryogenic containers can optionally be refuelled separately or jointly. It is a further objective of the invention to enable fast-fill refuelling of both cryogenic containers, which may be difficult because of long or separate line paths. In one aspect, the invention therefore relates to a system as described above with a second cryogenic container comprising a second filling line and a second removal line, each of them being routed individually or separately into the second cryogenic container, the filling lines of the two cryogenic containers optionally being connected via a connecting line, by means of which both the first-mentioned and the second cryogenic containers can be filled via the filling coupling of the first-mentioned cryogenic container.

In such a system with two cryogenic containers, it is preferred if the thermal bridge thermally connects a common removal line, which connects the removal lines of the two cryogenic containers, to both the filling line of the first cryogenic container and the filling line of the second cryogenic container. This is advantageous as it is not necessary to determine from which cryogenic container cryogenic fluid is being removed, and both filling lines can still be cooled.

Furthermore, the thermal bridge can preferably thermally connect the removal line of the first-mentioned cryogenic container, and optionally also the removal line of the second cryogenic container, or a common removal line, which connects the removal lines of the two cryogenic containers, to the connecting line. Cooling the connecting line is particularly advantageous since, in this way, it can be enabled that both cryogenic containers can be refuelled from one side, whereby, despite long line paths, fast-fill refuelling and equal refuelling—i.e., uniform refuelling of both cryogenic containers so as to permanently achieve an equal filling quantity—is possible.

The option of routing back the removal line through the filling line is also possible in a system with two cryogenic containers, e.g., if a first section of the removal line of the first cryogenic container, or optionally the common removal line, is routed back into the filling line of the first cryogenic container or into the connecting line at a first point and is routed out of the filling line of the first cryogenic container or out of the connecting line at a second point. In addition, it may be envisaged for the removal line of the second cryogenic container to be routed back into the filling line of the second cryogenic container or into the connecting line, if necessary.

Since long line paths may occur in some of the above-mentioned embodiments, it is furthermore preferred if a branch line is provided which connects two points of the removal line and connects in parallel the thermal bridge and/or the return of the removal line through a section of the filling line. In this way, a situational parallel connection of the thermal bridge or, respectively, the return point can be achieved in order to temporarily reduce pressure losses.

### BRIEF DESCRIPTION OF THE DRAWINGS

Advantageous and non-limiting embodiments of the invention are explained in further detail below with reference to the drawings.

FIG. 1 shows a system according to the invention for fast-fill refuelling of a cryogenic container in a first embodiment with a heat-conducting cable as a thermal bridge.

FIG. 2 shows a variant of FIG. 1, wherein the thermal bridge is formed by direct contact.

FIG. 3 shows a variant of FIG. 2, wherein the removal line is routed back through the filling line to form a thermal bridge.

FIG. 4 shows a variant of the embodiment of FIG. 1, wherein the filling line and the removal line are routed into the cryogenic container with a common connection line.

FIG. 5 shows a variant of the embodiments of FIG. 4.

FIG. 6 shows a system with two cryogenic containers that can be quickly refuelled separately.

FIG. 7 shows a variant of FIG. 6 in which both cryogenic containers can be quickly refuelled via a single filling coupling.

FIG. 8 shows a variant of the embodiment of FIG. 7.

FIG. 9 shows a detailed view of the system according to the invention.

### DETAILED DESCRIPTION

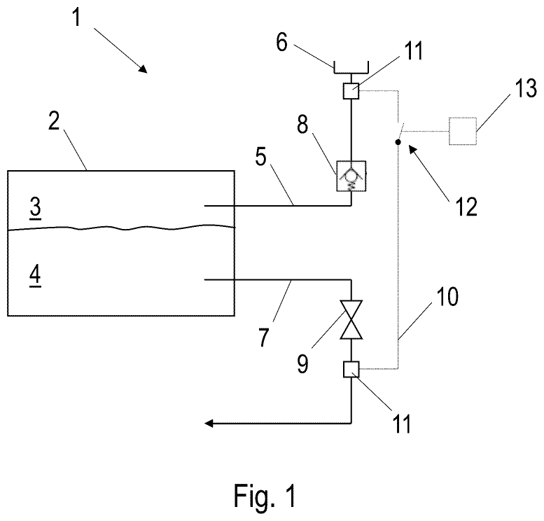

FIG. 1 shows a system 1 comprising a cryogenic container 2 in which cryogenic fluid in the gaseous state 3 or in the liquid state 4 is stored. For example, the cryogenic fluid can be hydrogen so that the cryogenic container 2 is a hydrogen container, or the cryogenic fluid can be LNG (Liquefied Natural Gas) so that the cryogenic container 2 is an LNG container. Depending on the cryogenic fluid, the cryogenic container 2 is therefore designed for storing cryogenic fluid at temperatures of, for example, below 150 Kelvin, in case of hydrogen even of below 50 Kelvin or below 30 Kelvin or essentially of 20 Kelvin. Depending on the application, the cryogenic container 2 could be designed, for example, for storing sLH2 (subcooled liquid hydrogen) or CcH2 (cryo-compressed hydrogen) and thus also for corresponding high pressures and sometimes also for higher temperatures, e.g., for maximum pressures of between 5 bar and 350 bar.

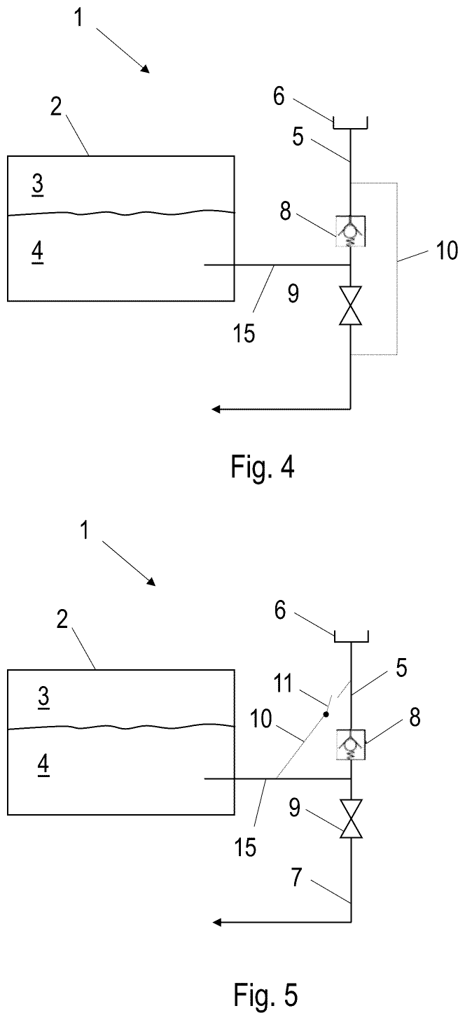

Furthermore, the system 1 has a filling line 5 routed into the cryogenic container 2 and comprising a filling coupling 6 as well as a removal line 7 routed into the cryogenic container 2. The filling line 5 can have a check valve 8 blocking in the direction of the filling coupling 6. The removal line 7 can, for example, comprise a manually or mechanically operable shut-off valve 9 for shutting off the removal line 7. As illustrated in FIGS. 1 to 3, the filling line 5 and the removal line 7 can be routed into the cryogenic container 2 separately from each other, or, as shown in FIGS. 4 and 5, the filling line 5 and the removal line 7 can be routed into the cryogenic container 2 by means of a common connection line 15. The components for refuelling the cryogenic container 2 and for removing cryogenic fluid from the cryogenic container 2 are generally referred to as the ancillary system of the system 1.

The cryogenic container 2 described herein is used as a fuel container of a vehicle (not illustrated any further) and can be mounted for this purpose, for example, on the vehicle frame of the vehicle. For supplying the cryogenic fluid as a fuel to a consumer of the vehicle, the removal line 7 is routed, for example, from the cryogenic container 2 to a consumer, such as an engine or a fuel cell, of the vehicle.

If the vehicle is parked or the system 1 is generally not in operation and no refuelling or, respectively, removal of cryogenic fluid from the cryogenic container 2 takes place, a temperature gradient will be established on the filling line 5 after a certain period of time upon refuelling, since the filling line 5 adjusts a temperature corresponding to the cold cryogenic fluid at the point leading into the cryogenic container 2 and a temperature corresponding to the warm environment at the point of the filling coupling 6. A similar temperature gradient will be established on the removal line 7 between the cryogenic container 2 and the passageway on the outer container of the cryogenic container 2 or, respectively, the vacuum jacket of the cryogenic container, which vacuum jacket is connected to the outer container.

However, when the system 1 is in operation, cold cryogenic fluid will flow through the removal line 7, whereby essentially the same cold temperature of the cryogenic fluid as that in the cryogenic container 2 will be established on the entire removal line 7. If no further measures are taken, such as the thermal bridge according to the invention as outlined below, the removal of cold cryogenic fluid via the removal line 7 would, however, not affect the thermal gradient of the filling line 5. At least after an extended journey, the ambient temperature will therefore be established at the filling coupling 6 and the previously explained thermal gradient will thus be established at the filling line 5.

However, the problem associated with a warm filling path or, respectively, a warm filling coupling 6 and a temperature gradient along the filling path is that direct refuelling of the cryogenic container 2 with cold cryogenic fluid cannot occur. If cold cryogenic fluid were to be introduced into the filling coupling, the cryogenic fluid would evaporate at this point until the filling coupling 6 has essentially reached the temperature of the cryogenic fluid. In this case, the refuelling cannot be called fast-fill refuelling, since cooling of the filling coupling 6 or, respectively, the filling line 5 takes a certain amount of time. The evaporation of cryogenic fluid at the beginning of such kind of refuelling also reduces the maximum mass which the cryogenic container can accommodate, since warmer cryogenic fluid (at the same density) generally has a lower density.

The solutions of FIGS. 1 to 8 as explained below achieve that the filling coupling 6 is operational at least immediately after the completion of a removal of cryogenic fluid from the cryogenic container 2, e.g., when the vehicle stops at a filling station after a journey.

In the embodiment of FIG. 1, the removal line 7 is thermally connected to the filling line 5 by means of a connectible thermal bridge. In this embodiment, the thermal bridge is formed by a heat-conducting connection 10, e.g., a cable or a mesh, in particular made of metal such as aluminium or copper. This cable or, more generally, the heat- conducting connection 10 can optionally be insulated towards the outside by means of an insulation such as a plastic layer. For example, a mesh would allow that several connection points can be provided on the removal line 7 and on the filling line 5 and that an essentially planar heat transfer can also take place. Furthermore, the heat-conducting connection 10 could be formed by a film or a plate. As understood herein, a film differs from a plate only in its flexibility. The film or plate can also be manufactured from metal, e.g., aluminium or copper. The heat-conducting connection 10 is preferably longer than 10 cm, preferably longer than 20 cm, preferably longer than 50 cm or preferably longer than 100 cm so that lines spaced apart from each other can also be interconnected.

For connecting the heat-conducting connection 10 to the removal line 7 or, respectively, to the filling line 5, a heat-conducting layer 11 enclosing the respective line 5, 7 at least in sections, in particular an aluminium strip, can be used. A first aluminium strip could thus be wrapped around the removal line 7, and a second aluminium strip could be wrapped around the filling line 5, and the cable or, respectively, the mesh could thermally connect the aluminium strips. The thermal bridge of FIG. 1 could be realized in this way, for example.

If the thermal bridge is permanent, i.e., no thermal bridge switch 12 as explained below is used, it is preferably envisaged that the heat capacity or, respectively, the thermal resistance or the length of the filling line 5 and the removal line 7 between the cryogenic container 2 and the connection point of the permanent thermal bridge to the respective line is essentially of the same magnitude. As a result, it may be envisaged that the permanent thermal bridge starts, in each case, at points on the lines 5, 7 with the same temperature gradient or, respectively, at points where the same temperature is established during an extended standstill. In other words, after the system has come to a standstill, what happens is that both the removal line 7 on the consumer side and the filling line 5 on the side of the filling coupling heat up. If the two ends of the thermal bridge heat up to the same extent, there will be no heat flow across the thermal bridge, i.e., no major heat input into the system, when the system is at a standstill. The length of the filling line 5 and/or the removal line 7 between the cryogenic container 2 and the thermal bridge ranges, for example, essentially between 300 mm and 700 mm.

In FIG. 1, it is furthermore illustrated that the thermal bridge could have an optional thermal bridge switch 12. The thermal bridge switch 12 is designed for preventing a thermal connection of the thermal bridge when the thermal bridge switch 12 is open. In other words, the heat-conducting connection can be separated by the thermal bridge switch 12. This allows, for example, the thermal bridge to be installed at any point on the filling line 5 or, respectively, the removal line 7 without having to consider points with the same temperature gradient. The thermal bridge switch 12 causes this solution to be more flexible in use, since the desired effect of cooling the filling path can be achieved even when the available installation space is very limited. Usually, the thermal bridge switch 12 is opened when the vehicle is parked or, respectively, the system 1 is switched off, and is closed when the vehicle or, respectively, the system 1 is put into operation, since, from this point on, cryogenic fluid will flow through the removal line 7.

The thermal bridge switch 12 can be operated manually, and, for this purpose, it can be arranged, for example, next to the filling coupling or in a driver's cab of the vehicle. However, alternatively or additionally, the system 1 could also comprise a control unit 13 which actuates the thermal bridge switch 12. In this case, the control unit 13 is designed for switching the thermal bridge on and off, with the control unit 13 preferably being designed for switching the thermal bridge on, i.e., closing the thermal bridge switch 12 when cryogenic fluid is being removed via the removal line 7, and/or switching the thermal bridge off, i.e., opening the thermal bridge switch 12 when no cryogenic fluid is being removed via the removal line 7. In order to detect a removal of cryogenic fluid via the removal line 7, the control unit 13 can be connected, for example, to a sensor, e.g., a level sensor in the cryogenic container 2, or to a mass flow meter in the removal line 7, or to receive a control signal from vehicle electronics indicating, for example, a consumer operation.

Furthermore, it is evident from FIG. 1 that the thermal bridge switch 12 in the heat-conduction connection 10 can preferably be provided closer to the connection point to the filling line 5 than to the connection point to the removal line 7. The reason for this is that, during a refuelling process, the heat-conduction connection 10, which possibly is warm, would also have to be cooled, which is avoided by the aforementioned arrangement of the switch in the vicinity of the filling line 5.

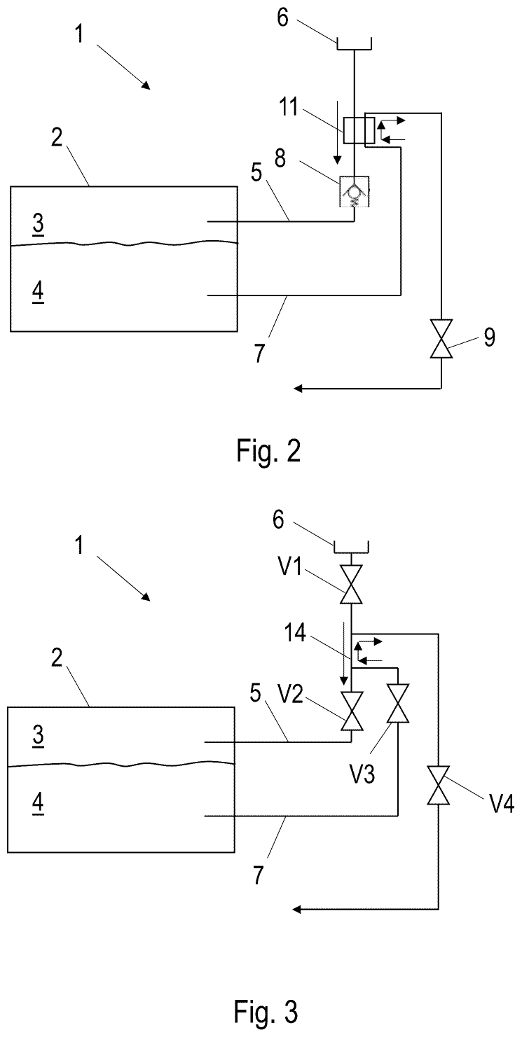

FIG. 2 shows an embodiment in which the thermal bridge is designed as an alternative to the embodiment of FIG. 1. Instead of a heat-conducting connection 10 designed as a cable, the thermal bridge can be formed by routing the filling line 5 and the removal line 7 in such a way that they lie next to each other at least at one point, thereby preferably contacting each other. Preferably, a heat-conducting layer 11 such as an aluminium strip can be wrapped around the two lines 5, 7 at this point in order to establish or, respectively, improve the contact. As a result, both lines 5, 7 are enclosed in sections by the heat- conducting layer 11. It is evident that this embodiment is functionally identical to that in FIG. 1 without a thermal bridge switch 12. In this case, it may also be envisaged that the thermal bridge is present at points on the filling line 5 or, respectively, the removal line 7 with an identical temperature gradient or temperature level after an extended standstill.

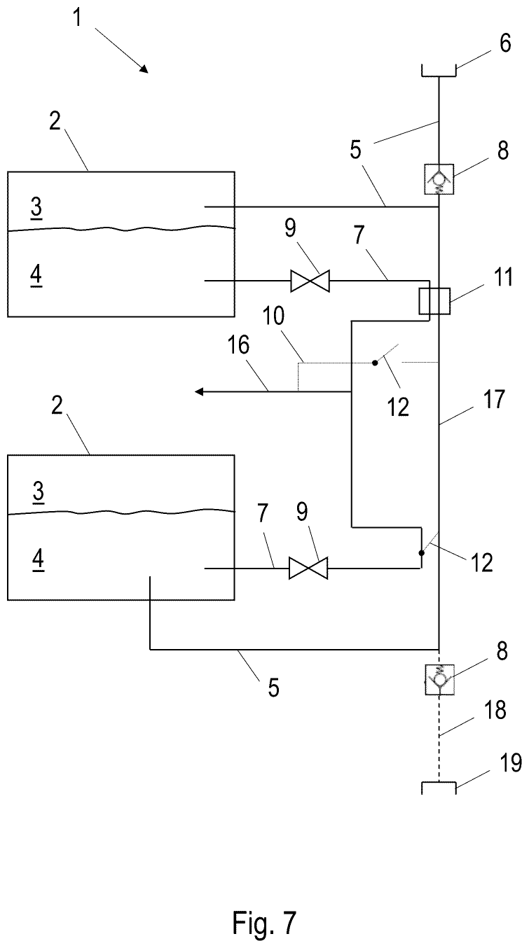

Alternatively, a thermal bridge switch 12 can also be provided in the embodiment of FIG. 2. For example, the lines 5, 7 could be located so as to be spaced apart from each other, for example, they could be spaced apart from each other with a maximum mutual distance of 10 cm or 20 cm, and a contact such as a plate or a rod could contact the two lines 5, 7 in a first operating state and could thermally separate them in a second operating state. This contact forms the thermal bridge switch 12 there and could, for example, be pivotally connected to one of the lines 5, 7 at one end, with the other end contacting the other line 5, 7 in the first operating state and adopting a distance from the other line in the other operating state. In FIG. 7, this is shown schematically for the lower cryogenic container 2.

With regard to FIGS. 1 and 2, it should also be noted that the arrangement of valves such as the check valve 8 in the filling line 5 can be chosen arbitrarily, although it is preferred that the thermal bridge is located directly next to the filling coupling 6, i.e., there is no valve in the filling line 5 between the thermal bridge and the filling coupling 6. The thermal bridge can preferably be installed so close to the filling coupling 6, but still within the vacuum space, that, in case of a prolonged removal, the temperatures will just not fall below, for example, temperatures hazardous to health at the filling coupling or, respectively, control surfaces in the immediate surroundings and will not fall there below a temperature of, e.g., −30° C., −20° C. or −10° C. The filling coupling 6 can be cooled efficiently using these solutions.

FIG. 3 is an embodiment that seems to be functionally similar to that of FIG. 2, but wherein the filling line 5 and the removal line 7 do not lie next to each other, but rather the removal line 7 is routed back in sections through the filling line 5. In other words, the filling line 5 and the removal line 7 share a common section 14. The filling line 5 then has a first filling section between the common section 14 and the filling coupling 6 and a second filling section between the common section 14 and the cryogenic container 2. The removal line 7 has a first removal section between the common section 14 and the consumer and a second removal section between the common section 14 and the cryogenic container 2.

It is illustrated schematically that there is a first valve VI in the first filling section, a second valve V2 in the second filling section, a third valve V3 in the first removal section and a fourth valve V4 in the second removal section, respectively. The valves V1-V4 could be operated manually or actuated automatically or could also be designed at least partially as check valves. If necessary, one or more valves V1-V4 could also be omitted. The invention is thus not limited to a specific arrangement of the valves V1-V4. During a filling process, for example, the valves V3, V4 in the removal sections are blocked so that the common section 14 acts as a section of the filling line 5. During a removal process, for example, the valves V1, V2 in the filling sections are blocked so that the common section 14 acts as a section of the removal line 7. The second removal section, in which the valve V4 is shown, could also be used simultaneously as a connecting line between two cryogenic containers, at least temporarily.

Such a return of the removal line 7 through the filling line 5 is advantageous because the common section and thus also a common section of the filling line 5 are cooled during a removal process. Subsequently, the filling coupling is also cooled during the removal process by thermal conduction. It is evident that the same effect as in the embodiments of FIGS. 1 and 2 is achieved, i.e., fast-fill refuelling is enabled immediately after the system 1 or, respectively, the vehicle has been switched off.

FIG. 4 shows an embodiment in which the filling line 5 and the removal line 7 are routed into the cryogenic container 2 via a common connection line 15, i.e., the filling line 5 and the removal line 7 share the section of the connection line 15. The embodiment of FIG. 1 can be provided analogously also in embodiments with a common connection line 15, wherein the thermal bridge in the form of a heat-conducting connection 10 starts with one end at the removal line 7 (i.e., at the connection line 15 or at the section of the removal line 7 between the connection line 15 and the consumer) and with the other end at a section of the filling line 5 which is located between the common connection line 15 and the filling coupling 6.

Especially if a permanent thermal bridge is provided, the thermal bridge can start with one end at the section of the removal line 7 between the connection line 15 and the consumer and with the other end at the section of the filling line 5 which is located between the common connection line 15 and the filling coupling 6. As a result, the thermal bridge can again start at points on the lines 5, 7 with the same temperature gradient and there is no heat flow across the thermal bridge when the system is switched off. This is illustrated in FIG. 4. In this embodiment, however, a thermal bridge switch 12 could, of course, also be used like in the embodiment of FIG. 1, with all the above-described variants.

In a system 1 with a common connection line 15, the thermal bridge could also be placed asymmetrically, as shown in FIG. 5. In other words, the heat-conducting connection 10 starts with one end at the common connection line 15 and with the other end at the section of the filling line 5 which is located between the common connection line 15 and the filling coupling 6. In this embodiment variant, it is recommended to use the described thermal bridge switch 12 in order to reduce the heat flow when the system is at a standstill, although this is not mandatory.

The variant of the system with a common connection line 15 can also be combined with direct contacts (FIG. 2) or a return (FIG. 3), as explained above.

Typically, it may happen that the system 1 has two or more cryogenic containers 2. For example, at least two cryogenic containers 2 are often carried along on a vehicle, wherein one can be located on the left and one can be located on the right on the vehicle frame. Alternatively or additionally, a further cryogenic container 2 could be arranged behind a driver's cab. Several cryogenic containers 2 could also be arranged vertically behind the driver's cab, or even a combination of the aforementioned options, e.g., at least two cryogenic containers 2 on the side of the vehicle frame and at least one behind the cab. In the simplest case, the system of FIGS. 1 to 5 is duplicated, i.e., both cryogenic containers 2 have their own filling line 5 and their own removal line 7, which do not interact with each other. In this case, the two subsystems could each have a separate thermal bridge, as in FIGS. 1 to 5.

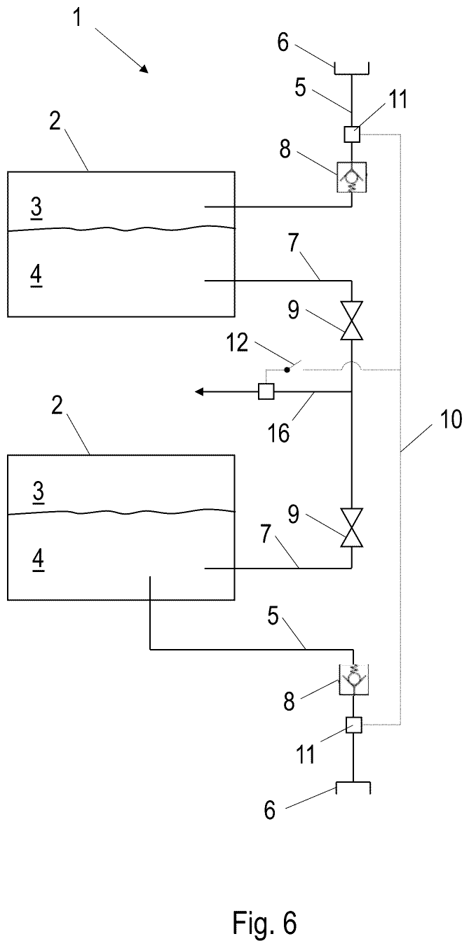

However, it is preferably envisaged that a common thermal bridge is used for two cryogenic containers 2. In this sense, reference is made below to the embodiments of FIGS. 6 to 8, in which common thermal bridges are used each time.

In the embodiment of FIG. 6, two cryogenic containers 2 are provided, each of which is refuelled via its own filling line 5 or, respectively, filling coupling 6. However, the removal lines 7 routed into the respective cryogenic containers 2 can be connected and routed to the consumer as a common removal line 16. During such a removal, it may happen that cryogenic fluid is temporarily removed only from one of the two cryogenic containers 2, for example due to different fill levels or pressure conditions. In order to ensure constant fast-fill refuelling for both filling couplings 6, a heat-conducting connection 10 with a branch is provided, whereby the heat-conducting connection 10 has at least three ends. A first end is connected to the common removal line 16, a second end is connected to the filling line 7 of the first cryogenic container 2, and a third end is connected to the filling line 7 of the second cryogenic container 2. As a result, fast-fill refuelling can occur for both filling couplings 6, regardless of the cryogenic container from which cryogenic fluid was removed prior to a desired removal. This effect could also be achieved if a heat-conducting connection 10 with four ends is used, which starts with one end at the filling line 5 of the first or second cryogenic container 2 and, respectively, with one end at the removal line 7 of the first or second cryogenic container 2.

FIG. 7 shows an embodiment in which both cryogenic containers 2 can be refuelled via a common filling coupling 6. For this purpose, a connecting line 17 is connected to the filling line 5 of the first cryogenic container 2 and to the filling line 5 of the second cryogenic container 2 (the filling coupling 6 of the second cryogenic container 2 being optional, see below). If cryogenic fluid is now introduced into the filling coupling 6 of the first cryogenic container 2, the cryogenic fluid introduced into it will flow into the first and/or second cryogenic container 2 depending on the respective pressure conditions prevailing. If necessary, valves could be provided in one or both filling lines 5 and/or the connecting line 17 in order to selectively control a fluid flow into the respective cryogenic container 2. Optionally, the filling line 5 of the second cryogenic container 2 can be extended with a section 18 and can have a further filling coupling 19 at one end of the section 18, as illustrated in FIG. 7 with a dashed line. If, on a vehicle, the filling coupling 6 is provided on one side of the vehicle and the further filling coupling 19 is provided on the other side of the vehicle, a user can refuel both cryogenic containers 2 simultaneously, regardless of the side he or she is located on.

It should be noted that what matters for fast-fill refuelling of both cryogenic containers 2 is not, or not only, a cold filling coupling 6, but in particular also a cold connecting line 17. If, for example, only the filling line 5 and the filling coupling 6 were cooled, but not the connecting line 17, the first cryogenic container 2 could indeed be quickly refuelled, but not the second cryogenic container 2, since the warm connecting line would cause the cryogenic fluid to evaporate.

In FIG. 7, alternative options for cooling the connecting line 17 are provided, which, however, could also be combined. On the one hand, a heat-conducting connection 10 could be used which starts with one end at the common removal line 16 and with the other end at the connecting line 17. However, a heat-conducting connection 10 with more than two ends could also be used, with one or more ends being attached at the following points: at the removal line 7 intended only for the first cryogenic container 2, at the removal line 7 intended only for the second cryogenic container 2 and/or at the common removal line 16. Furthermore, one or more ends is/are attached at the following points: at one or more points on the connecting line, at the filling line 5 intended only for the first cryogenic container 2, at the filling line 5 intended only for the second cryogenic container 2, at the filling coupling 6 and/or at the further filling coupling 19. Again, it could be envisaged that the heat-conducting connection 10 is connected to the filling line 5 near the filling couplings 6 while still within the vacuum space so that the cooling effect does not fall below temperatures that are harmful to health or, respectively, critical to safety (oxygen liquefaction temperature).

On the other hand, the two removal lines 7, through which, in each case, only cryogenic fluid is removed from one of the cryogenic containers 2, could each be routed to the connecting line 17 and contact it, as described above, or, respectively, a heat-conducting layer 11 could be wrapped around the two lines there (shown for the upper cryogenic container 2), or, respectively, a thermal bridge switch 12 could be present there (shown for the lower cryogenic container 2). Likewise, it would be possible to route only the common removal line 16 to the connecting line 17 and to establish a single contact on the connecting line 17 in this manner.

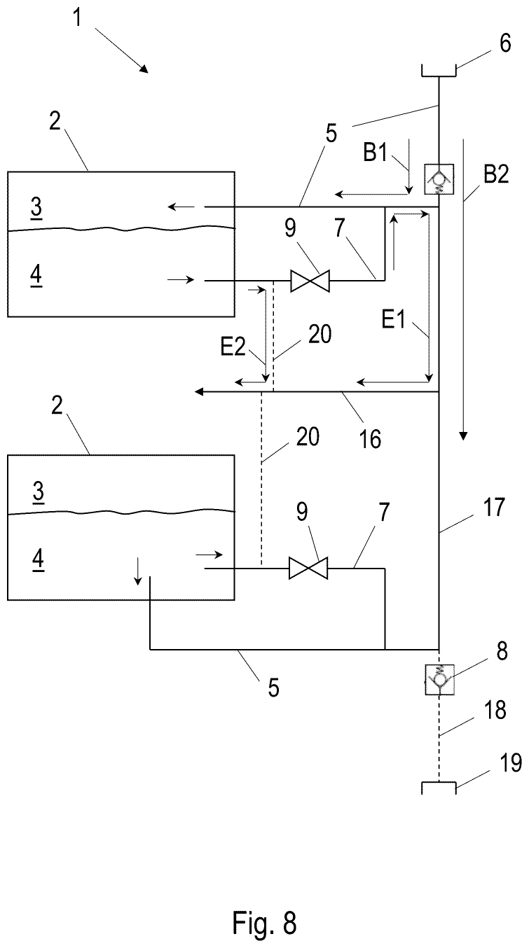

In the embodiments with a heat-conducting connection 10, a permanent thermal bridge can be used, as explained above, or a thermal bridge with a thermal bridge switch 12, which is optionally actuated by a control unit 13. All variants previously described for FIGS. 1 to 5 are applicable also to the embodiments of FIGS. 6 and 7 or, respectively, of FIG. 8, which will be explained below.

An embodiment with return of the removal line 7 via the filling line 5 and the connecting line 17 is illustrated in FIG. 8. In this case, the first removal line 7 is connected to the filling line 5. The common removal line 16 is connected to the connecting line 17. It is evident that part of the filling line 5 is used both for refuelling and for removing cryogenic fluid. Likewise, part of the connecting line 17 is used both for refuelling and for removing cryogenic fluid.

For the sake of greater clarity, control valves for this method are not depicted, but the filling paths and removal paths are schematically denoted by B1, B2, E1 and E2. A valve circuit for this purpose can easily be selected by a person skilled in the art. In the filling path B1, cryogenic fluid is introduced into the filling coupling 6 and filled into the first cryogenic container 2 via the filling line 5, and thus also via the common section of the filling line. In the filling path B2, cryogenic fluid is introduced into the filling coupling 6 and filled into the second cryogenic container 2 via the connecting line 17, and thus also via the common section of the connecting line 17. In the first removal path E1, cryogenic fluid is removed from the cryogenic container 2 via the removal line 7, and conducted to the common removal line 16 via the common section of the filling line 5 and the common section of the connecting line 17.

Optionally, a further branch line 20 routed between the respective removal line 7 and the common removal line 16 can be provided in order to guide cryogenic fluid via the removal path E2, thus reducing pressure losses in the system. If it is determined, for example, that the connecting line 17 and/or the filling lines 5 and/or the filling couplings 6, 19 are cold enough or a quick start is not desired, cryogenic fluid can be removed via the removal path E2 selectively via the branch line 20, whereby line paths and consequently pressure losses are reduced. Furthermore, this could also be provided in the embodiment explained with reference to FIG. 7. The temperature of the respective lines can be measured by sensors. A or, respectively, the above-mentioned control unit 13 can preferably switch the branch line 20 on or off automatically, based on the data measured by the sensors. The branch line 20 connecting in parallel in the removal line 7 could also be used in other embodiments, even with only one cryogenic container 2, in particular for shortening long line paths that may occur with direct contacts as in FIG. 2 or with returns as in FIG. 3.

As an alternative to the variant illustrated in FIG. 8, even only the common removal line 16 can be routed back through the connecting line 17, or the respective removal lines 7 can be routed back only through the connecting line 17 or only through the respective filling line 5.

Furthermore, it shall be understood that the thermal bridges do not have to be designed symmetrically, as illustrated in FIGS. 6 to 8. For example, an embodiment such as for the upper cryogenic container 2 in FIG. 7 could be used for one of the cryogenic containers 2, and an embodiment such as for the lower cryogenic container 2 in FIG. 8 could be used for the other cryogenic container 2, wherein additional valves could optionally be used for controlling the cryogenic fluid flow. This system could optionally have an additional thermal bridge switch 12. Other combinations of the thermal bridges described herein for a system with two cryogenic containers 2 are also possible.

When it is mentioned herein that, for example, the heat-conducting connection 10 is in contact with the filling line 5, the removal line 7, the common removal line 16 or the connecting line 17, the contact can either be made at certain points, e.g., if the heat-conducting layer 11 is wrapped around the respective pipeline at a specific point. Alternatively, a planar contact can also be provided, e.g., if the heat-conducting layer encloses the respective line across a certain length. Furthermore, several point-like contacts could also be provided as an alternative, e.g., if the heat-conducting layer 11 is divided at its end into several strands which are attached to the respective line at several different points, e.g., wrapped around the respective line at several points.

Furthermore, reference is made above to the fact that the heat-conducting connection 10 contacts the filling line 5 or, respectively, the connecting line 17. It will be appreciated that, with such contact by thermal conduction, the filling coupling 6 or, respectively, the filling couplings 6, 19 are also cooled. However, it may be envisaged alternatively or additionally that the heat-conducting connection 10 contacts the respective filling coupling 6, 19 directly.

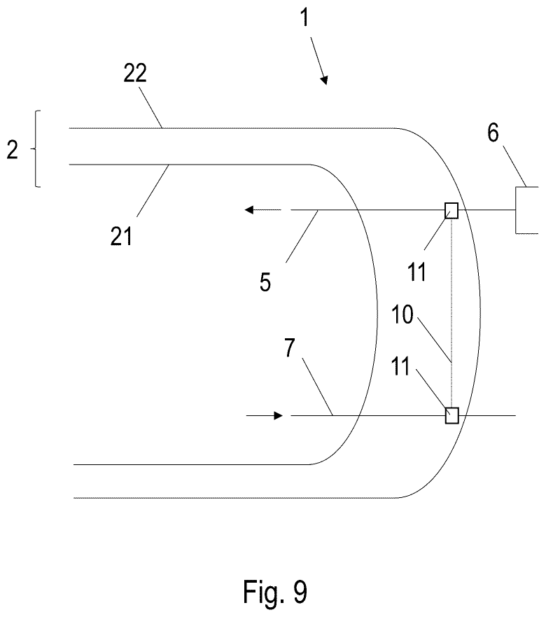

FIG. 9 shows that the cryogenic container(s) 2 described herein usually has (have) an inner tank 21 and an outer container 22 vacuum-insulated relative to the inner tank 21. It is evident that part of the filling line 5 and part of the removal line 7 are located within this vacuum-insulated space between the inner tank 21 and the outer container 22. If such a system is brought to a standstill, i.e., no cryogenic fluid flows through the lines 5, 7, heat input into the cryogenic container 2 will occur via the respective line 5, 7, since there is a temperature difference between the inside of the inner container 2 and the outside of the outer container 22. In other words, a temperature gradient is established on the respective line 5, 7. Preferably, the thermal bridge or, respectively, the section for return is located entirely within the outer container 22 and starts at points with the same temperature gradient, i.e., at points on the filling line 5 and the removal line 7 where an identical temperature is established after the system has come to a standstill. As a result, there is no heat flow across the thermal bridge or the section, respectively. Alternatively, the thermal bridge or, respectively, the section for return could be located completely outside of the outer container 22, also in this case with no heat flow occurring across the thermal bridge or the section, respectively. It shall be understood that a thermal bridge switch 12 could be used for the thermal bridge also in the embodiment of FIG. 9, which thermal bridge switch could be located entirely within the outer container 22 also in this case. A control line connected to the thermal bridge switch 12 could be routed to a control unit 11 located outside of the outer container 22.

In all embodiments, the thermal bridge, e.g., if it is designed as a heat-conducting connection 10, could also be connected with one end to one of the lines 5, 7 in the space between the inner tank 21 and the outer container 22 and with the other end to the other line 5, 7 or, respectively, the connecting line 17 outside of the outer container 22.

1-10. (canceled)

11. A system for fast-fill refuelling of a cryogenic container, the system comprising:
a vehicle, wherein the cryogenic container is mounted on the vehicle; and
an ancillary system for filling the cryogenic container with cryogenic fluid and for removing cryogenic fluid from the cryogenic container, the ancillary system comprising:
a filling line with a filling coupling and a removal line routed to a consumer, with the filling line and the removal line each being routed into the cryogenic container separately or via a common connection line,
wherein
a) the removal line and/or the connection line is/are thermally connected to the filling line, the filling coupling and/or the connecting line connected to the filling line by means of a permanent or connectible thermal bridge, the permanent thermal bridge being formed by a heat-conducting connection, by a cable, a mesh, a plate or a film, or by a direct contact, or
b) the removal line and/or the connection line is/are routed back through a section of the filling line and/or the connecting line.

12. The system according to claim 11, wherein the cryogenic container has an inner tank and an outer container that is vacuum-insulated relative to the inner tank, and the thermal bridge or the section for return is provided in a space between the inner tank and the outer container, with the thermal bridge or the section for return preferably being provided at points on the filling line and the removal line where an identical temperature is established after the system has come to a standstill.

13. The system according to claim 11, furthermore comprising a control device which is designed for switching the thermal bridge on and off, with the control device being designed for switching the thermal bridge on when cryogenic fluid is being removed via the removal line and/or for switching the thermal bridge off when no cryogenic fluid is being removed via the removal line.

14. The system according to claim 11, wherein the heat-conducting connection is made of metal, and/or wherein a heat-conducting layer enclosing the respective line is provided, preferably an aluminium strip, which is connected to the heat-conducting connection.

15. The system according to claim 11, wherein the filling line and the removal line or the connection line are located directly next to each other at this point to form the thermal bridge and contact each other there, and/or wherein a heat-conducting layer wrapped around the two lines is provided and/or wherein the two lines are spaced apart at a predetermined distance, which amounts, for example, to a maximum of 10 cm or 20 cm, and can be selectively contacted using the thermal bridge.

16. The system according to claim 11, furthermore comprising a second cryogenic container comprising a second filling line and a second removal line, the filling lines of the two cryogenic containers optionally being connected via a connecting line, by means of which both the cryogenic container and the second cryogenic container can be filled via the filling coupling of the cryogenic container.

17. The system according to claim 16, wherein the thermal bridge thermally connects a common removal line, which connects the removal lines of the two cryogenic containers, to both the filling line of the cryogenic container and the filling line of the second cryogenic container.

18. The system according to claim 16, wherein the thermal bridge thermally connects the removal line of the cryogenic container, and optionally also the removal line of the second cryogenic container, or a common removal line, which connects the removal lines of the two cryogenic containers, to the connecting line.

19. The system according to claim 16, wherein a first section of the removal line of the cryogenic container, or the common removal line, is routed back into the filling line of the first cryogenic container or into the connecting line at a first point and is routed out of the filling line of the first cryogenic container or out of the connecting line at a second point.

20. The system according to claim 11, comprising a branch line which connects two points of the removal line and connects in parallel the thermal bridge and/or a return of the removal line through a section of the filling line.
